(19) United States
(12) Patent Application Publication
(10) Pub. No.: US 2026/0196497 A1
(43) Pub. Date: Jul. 9, 2026

(54) TRIMAGNESIUM DISULFIDE-CONTAINING COMPOUND AND SECONDARY BATTERY

(71) Applicants: MURATA MANUFACTURING CO., LTD., Kyoto (JP); Cambridge Enterprise Limited, Cambridge (GB)

(72) Inventors: Yuri NAKAYAMA, Kyoto (JP); Daisuke MORI, Kyoto (JP); Yoshiaki SUZUKI, Kyoto (JP); Kazuhiro KAMIGUCHI, Kyoto (JP); Sunita DEY, Cambridge (GB); Clare GREY, Cambridge (GB); Christopher O'KEEFE, Cambridge (GB); Jeongjae LEE, Cambridge (GB)

(21) Appl. No.: 19/550,571

(22) Filed: Feb. 26, 2026

Related U.S. Application Data
(63) Continuation of application No. PCT/JP2024/027829, filed on Aug. 2, 2024.

(30) Foreign Application Priority Data
Aug. 31, 2023 (JP) 2023-141010

(51) Int. Cl. H01M 4/58; H01M 4/02; H01M 4/38; H01M 10/054; H01M 10/0568; H01M 10/0569

(52) U.S. Cl. CPC H01M 4/5815; H01M 4/381; H01M 10/054; H01M 10/0568; H01M 10/0569; H01M 2004/021; H01M 2004/027; H01M 2004/028

(57) ABSTRACT

A secondary battery is provided and including a positive electrode that includes a sulfur-containing material; a negative electrode that includes a magnesium-containing material; and an electrolytic solution, wherein the sulfur-containing material includes trimagnesium disulfide (Mg₃S₂) in a discharged state.

### CROSS-REFERENCE TO RELATED APPLICATIONS

The present application is a continuation of PCT patent application no. PCT/JP2024/027829, filed on Aug. 2, 2024, which claims priority to Japanese Patent Application No. 2023-141010, filed on Aug. 31, 2023, the entire contents of which are incorporated herein by reference.

### BACKGROUND

The present disclosure relates to a trimagnesium disulfide-containing compound and a secondary battery.

With dissemination of a variety of electronic devices including mobile phone, there is an ongoing development of secondary battery, expected as a small, light-weight, and high-power-density power supply.

A particular focus has been placed on a secondary battery that uses sulfur as a positive electrode active material.

More specifically, there has been proposed a secondary battery having a sulfur-containing positive electrode and a magnesium-containing negative electrode, for which reversibility of a charge-discharge reaction has been evaluated by X-ray photoelectron spectroscopy.

In a magnesium secondary battery in which a battery reaction reversibly proceeds, magnesium sulfide as a discharge product has a zinc blende-type crystal structure.

Although various studies have been made on structure of the secondary battery, battery characteristic of the secondary battery still remains insufficient, thus leaving a room for improvement.

### SUMMARY

The present disclosure relates to a trimagnesium disulfide-containing compound and a secondary battery.

Although various studies have been made on structure of the secondary battery, battery characteristic of the secondary battery still remains insufficient, thus leaving a room for improvement. In this case, it is also important to develop a new material that contains sulfur as a constituent element, to improve the battery characteristic.

A trimagnesium disulfide-containing compound and a secondary battery capable of obtaining excellent battery characteristic have been desired.

The “sulfur-containing material” herein is used as a collective term for materials that contain sulfur as a constituent element, and the “magnesium-containing material” is used as a collective term for materials that contain magnesium as a constituent element.

Details of the sulfur-containing material and the magnesium-containing material will be individually described later.

The “discharged state” is not particularly limited as long as the secondary battery is in a discharged state.

The discharged state will be described later in detail.

According to a trimagnesium disulfide-containing compound of an embodiment of the present technology, with trimagnesium disulfide contained therein, excellent electrochemical characteristics will be obtainable in electrochemical devices such as secondary battery, to which the trimagnesium disulfide-containing compound is applied.

According to a secondary battery of an embodiment of the present technology, the positive electrode includes the sulfur-containing material, the negative electrode includes the magnesium-containing material, and the sulfur-containing material includes trimagnesium disulfide in the discharged state.

According to a secondary battery of another embodiment of the present technology, the positive electrode includes the sulfur-containing material, the negative electrode includes the magnesium-containing material, the sulfur-containing material includes sulfur and magnesium as constituent elements in a discharged state, and the positive electrode in a discharged state demonstrates a first peak, in a result of analysis by magnesium-25 nuclear magnetic resonance spectroscopy.

### BRIEF DESCRIPTION OF THE FIGURES

FIG. 1 is a perspective view illustrating a structure of a secondary battery according to an embodiment of the present technology;

FIG. 2 is a cross-sectional view illustrating a structure of a battery element illustrated in FIG. 1;

FIG. 3 is a cross-sectional view illustrating another structure of the battery element illustrated in FIG. 1;

FIG. 4 is a diagram for explaining results of analysis of a positive electrode in a discharged state of the secondary battery, with use of magnesium-25 nuclear magnetic resonance spectroscopy;

FIG. 5 is a diagram for explaining results of analysis of a positive electrode in a discharged state of the secondary battery, with use of sulfur-33 nuclear magnetic resonance spectroscopy; and

FIG. 6 is a cross-sectional view illustrating a structure of a test secondary battery.

### DETAILED DESCRIPTION

The present disclosure will be described in further detail according to an embodiment. Note that the present disclosure is not limited thereby.

First, a trimagnesium disulfide-containing compound according to an embodiment of the present technology will be described.

The trimagnesium disulfide-containing compound, which contains sulfur as a constituent element, is a novel substance that occludes and releases magnesium. More specifically, the trimagnesium disulfide-containing compound contains magnesium together with sulfur as constituent elements, and more specifically contains trimagnesium disulfide (Mg₃S₂).

The trimagnesium disulfide-containing compound is applicable to any of freely selectable devices not particularly limited. In particular, the trimagnesium disulfide-containing compound is preferably applicable to electrochemical device that utilizes charge-discharge reaction. This is because the electrochemical device, to which the trimagnesium disulfide-containing compound is applied, can obtain excellent electrochemical characteristics ascribed to properties of the trimagnesium disulfide-containing compound.

Types of the electrochemical device specifically, but not restrictively, include battery and capacitor. The battery may be primary battery or secondary battery.

Method of producing trimagnesium disulfide-containing compound is not particularly limited.

This trimagnesium disulfide-containing compound may be formed by any of known synthesis methods. Alternatively, the trimagnesium disulfide-containing compound, if applied to the electrochemical device, may be formed during operation of such electrochemical device. To give an example, the trimagnesium disulfide-containing compound in battery or other electrochemical device may be formed making use of an electrochemical reaction that proceeds during operation of the electrochemical device.

A specific production procedure of the trimagnesium disulfide-containing compound will be described later, by exemplifying a case where the compound is formed during operation of a secondary battery as an electrochemical device.

The trimagnesium disulfide-containing compound excels in occlusion/release performance of magnesium, due to trimagnesium disulfide contained therein. Hence, the electrochemical reaction with use of the trimagnesium disulfide-containing compound will be more likely to proceed stably in the electrochemical device to which the trimagnesium disulfide-containing compound is applied, whereby excellent electrochemical characteristic will be obtainable.

In particular, the trimagnesium disulfide-containing compound, applied to secondary battery, will make the charge-discharge reaction with use of occlusion/release of magnesium more stably proceed. A high battery capacity will therefore be obtainable, and this achieves secondary battery having excellent battery characteristic.

First, a secondary battery according to an embodiment of the present technology, as an exemplary electrochemical device to which the aforementioned trimagnesium disulfide-containing compound is applied, will be described.

The secondary battery described herein makes use of occlusion/release of magnesium by the trimagnesium disulfide-containing compound, as well as deposition/dissolution of magnesium. This allows the secondary battery to proceed with a charge-discharge reaction, whereby battery capacity is obtainable.

More specifically, the secondary battery described below is a so-called magnesium-sulfur secondary battery, in which the positive electrode contains a sulfur-containing material, and the negative electrode contains a magnesium-containing material. Details of the sulfur-containing material and the magnesium-containing material will be described later.

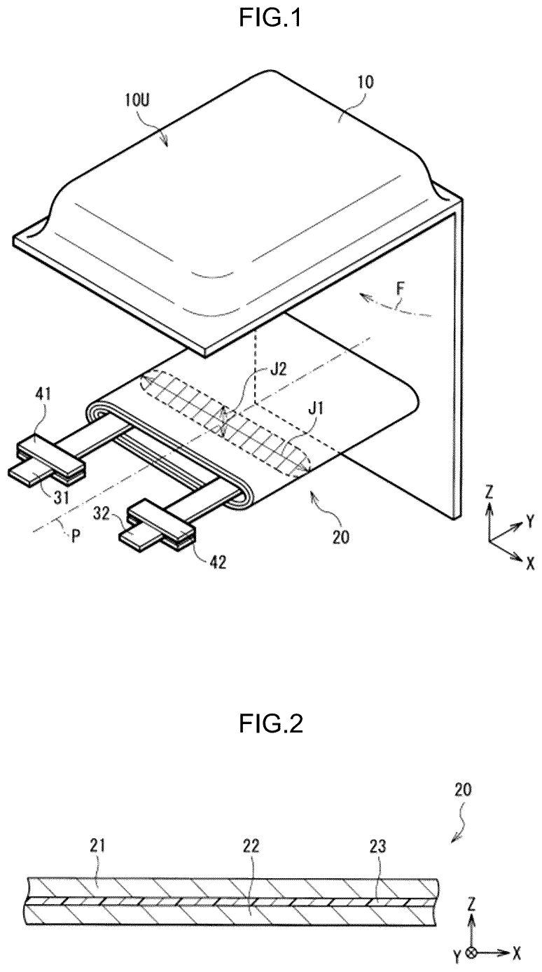

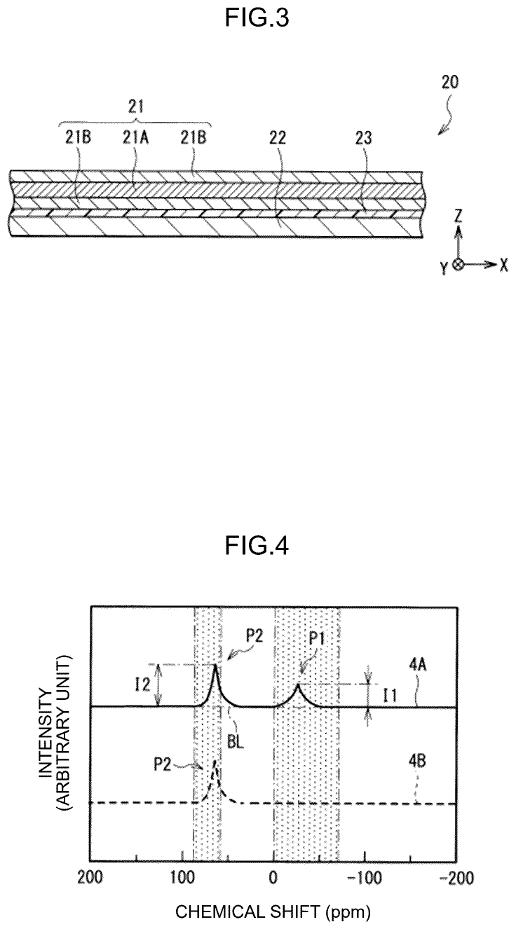

FIG. 1 illustrates a perspective structure of the secondary battery. Each of FIGS. 2 and 3 illustrates a cross-sectional structure of a battery element 20 illustrated in FIG. 1. Note FIG. 1 illustrates an exterior film 10 and the battery element 20 separated from each other, with a cross section of the battery element 20 in the X-Z plane indicated by a broken line.

As illustrated in FIGS. 1 to 3, the secondary battery has the exterior film 10, the battery element 20, a positive electrode lead 31, a negative electrode lead 32, and sealing films 41 and 42.

The secondary battery described herein, with use of the exterior film 10 which is a flexible or soft exterior member, is a so-called laminate film-type secondary battery.

The exterior film 10, as illustrated in FIG. 1, has a pouch-like structure, which is sealed while accommodating therein the battery element 20. The exterior film 10 therefore accommodates a positive electrode 21, a negative electrode 22, a separator 23 and an electrolytic solution described later.

The exterior film 10 herein is a single film-like member, and is folded in a folding direction F. The exterior film 10 has a recess 10U, into which the battery element 20 is accommodated. The recess 10U is formed as a so-called, deep-drawn portion.

More specifically, the exterior film 10 is a three-layered laminate film in which a melt-bonding layer, a metal layer, and a surface protective layer are laminated in this order from the inner side. The exterior film 10 is folded, with the opposing outer peripheries of the melt-bonding layer melt-bonded. The melt-bonding layer contains a polymer compound such as polypropylene. The metal layer contains a metal material such as aluminum. The surface protective layer contains a polymer compound such as nylon.

The structure (number of layers) of the exterior film 10 is not particularly limited, to which a single layer, double layers, or four or more layers may be applicable.

The battery element 20 is, as illustrated in FIGS. 1 to 3, a power generating element accommodated in the exterior film 10, and has the positive electrode 21, the negative electrode 22, the separator 23, and the electrolytic solution (not illustrated).

The battery element 20 herein is a so-called rolled electrode body. The positive electrode 21 and the negative electrode 22 are therefore opposed while placing the separator 23 in between, and rolled around the axis of rolling P. The axis of rolling P is a virtual axis that extends in the Y-axis direction, as illustrated in FIG. 1.

The three-dimensional shape of the battery element 20 is not particularly limited. The battery element 20 herein has an oblate three-dimensional shape. The shape of a cross section, crossing the axis of rolling P, of the battery element 20 is therefore given by an oblate shape specified by a major axis J1 and a minor axis J2. The cross section described herein is taken in the X-Z plane.

The major axis J1 is a virtual axis that extends in the X-axis direction, and has a length longer than that of the minor axis J2. The minor axis J2 is a virtual axis that extends in the Z-axis direction, which crosses the X-axis direction, and has a length shorter than that of the major axis J1. The three-dimensional shape of the battery element 20 herein is an oblate tubular shape, so that the cross-sectional shape of the battery element 20 is a near-elliptic oblate shape.

The positive electrode 21 illustrated in FIG. 2 contains a positive electrode active material that occludes and releases magnesium, wherein the positive electrode active material contains any one kind of, or two or more kinds of the sulfur-containing materials. This is because the positive electrode 21 will more easily occlude or release magnesium, and will be more likely to allow the charge-discharge reaction to proceed, making use of deposition/dissolution of magnesium.

The sulfur-containing material herein is a collective term for materials that contain sulfur as a constituent element, as described previously. The sulfur-containing material may, therefore, be elemental sulfur(S), sulfur-containing alloy, sulfur compound, or mixture of two or more of these species.

The elemental sulfur, whose purity is not particularly limited, may contain an unspecified amount of impurity.

The kind of metal element contained as the constituent element in the sulfur-containing alloy is not particularly limited, and may be any one kind of, or two or more kinds of unspecified metal elements. The sulfur compound contains any one kind of, or two or more kinds of nonmetallic elements such as carbon, oxygen, and halogen as the constituent elements. Specific examples of the halogen include fluorine, chlorine, bromine, and iodine. Note the trimagnesium disulfide-containing compound is excluded from the sulfur compound described herein.

In particular, the sulfur-containing material preferably contains elemental sulfur. This is because the charge-discharge reaction based on deposition/dissolution of magnesium can fully proceed.

Hereinafter, a state of the secondary battery before discharging will be referred to as “undischarged state”, and a state of the secondary battery after discharging will be referred to as “discharged state”. The magnesium-sulfur secondary battery stays in a fully charged state as manufactured (initial state not having been charged or discharged), and the fully charged state is included in the “undischarged state”.

As described previously, the sulfur-containing material in the undischarged state contains any one kind of, or two or more kinds of elemental sulfur, sulfur-containing alloy, or sulfur compound. In particular, the sulfur-containing material preferably contains elemental sulfur, as described previously.

On the other hand, the sulfur-containing material in the discharged state contains trimagnesium disulfide-containing compound. The trimagnesium disulfide-containing compound contains trimagnesium disulfide, as described previously.

That is, the composition of the sulfur-containing materials differs before and after discharge. More specifically, the sulfur-containing material does not contain the trimagnesium disulfide-containing compound in the undischarged state, whereas it contains the trimagnesium disulfide-containing compound in the discharged state.

The reason why the sulfur-containing material contains the trimagnesium disulfide-containing compound in the discharged state is that the trimagnesium disulfide-containing compound herein is a substance formed when the secondary battery is allowed to discharge (so-called discharge product) as will be described later.

The discharged state means a state in which the secondary battery has already been discharged. The state of the secondary battery in the discharged state is therefore not particularly limited, as long as the secondary battery has been discharged as described previously. That is, the battery voltage of the secondary battery in the discharged state is not particularly limited, as long as the secondary battery has been discharged, and thus may be set freely. This is because, if even a slight degree of discharge has occurred in the secondary battery, the trimagnesium disulfide-containing compound would be formed when the secondary battery is allowed to discharge.

More specifically, the discharged state means a state in which the secondary battery, with use of elemental magnesium for the negative electrode active material (magnesium-containing material) described later, has been discharged until the battery voltage reached 0.4 V. That is, the discharged state is such that the magnesium-containing material is dissolved in the negative electrode 22, so that magnesium stays occluded in the positive electrode 21. Conditions such as environmental temperature and discharge current during the discharge are not particularly limited, and may be set freely.

In a case where the secondary battery is brought into the discharged state by allowing the secondary battery to discharge until the battery voltage reaches 0.4 V, a test secondary battery (coin-type magnesium-sulfur secondary battery) is manufactured with use of elemental magnesium (magnesium plate) as the negative electrode 22 (magnesium-containing material), as described later in Example 1. Thereafter, the test secondary battery is allowed to discharge in a normal temperature environment (temperature=25° C.), at a current of 0.2 mA until the battery voltage reaches 0.4 V.

The reason why the discharged state is defined by a state in which the secondary battery has been discharged until the battery voltage reached 0.4 V is that the trimagnesium disulfide-containing compound will be sufficiently formed, as a result of the discharge of the secondary battery up to this state. The trimagnesium disulfide-containing compound will therefore become detectable, by analyzing the positive electrode 21 taken out from the secondary battery in the discharged state.

In contrast, the undischarged state means a state in which the secondary battery has not yet been discharged. More specifically, the undischarged state means a state in which the battery voltage is 1.0 V or above, in a case where elemental magnesium is used for the negative electrode active material (magnesium-containing material) described later, and the magnesium-containing material remains undissolved yet in the negative electrode 22. That is, the undischarged state is such that the magnesium-containing material remains undissolved and deposited in the negative electrode 22, and magnesium therefore remains unoccluded yet in the positive electrode 21.

The reason why the sulfur-containing material contains the trimagnesium disulfide-containing compound in the discharged state is that the electrochemical state of the positive electrode 21 during charge-discharge of the secondary battery will be improved, and thus a high battery capacity will be obtainable, as compared with the case where the sulfur-containing material does not contain the trimagnesium disulfide-containing compound in the discharged state.

In more detail, if the sulfur-containing material does not contain the trimagnesium disulfide-containing compound in the discharged state, increase in the areal density of the sulfur-containing material in the positive electrode 21 will considerably elevate the electrical resistance of the positive electrode 21. This makes the charge-discharge reaction based on deposition/dissolution of magnesium less likely to proceed, so that increase in the areal density of the sulfur-containing material will conversely decrease the energy density of the positive electrode 21. Use of deposition/dissolution of magnesium will therefore fail in obtaining high battery capacity. In this case, the charge-discharge reaction per se will not proceed depending on the areal density of the sulfur-containing material, thus making the battery capacity not obtainable from the beginning.

On the other hand, in a case where the sulfur-containing material does not contain the trimagnesium disulfide-containing compound in the discharged state, decrease in the areal density of the sulfur-containing material in the positive electrode 21 will decrease the electrical resistance of the positive electrode 21, rather than increasing it. A high battery capacity will, however, not be obtainable, since the energy density of the positive electrode 21 decreases due to the decrease in the areal density of the sulfur-containing material, as a matter of course.

In contrast, in a case where the sulfur-containing material contains the trimagnesium disulfide-containing compound in the discharged state, the amount of occlusion of magnesium in the sulfur-containing material will increase, owing to the property of the trimagnesium disulfide-containing compound. Moreover, owing to the property of the trimagnesium disulfide-containing compound, the positive electrode 21 will be suppressed from increasing the electrical resistance, even if the areal density of the sulfur-containing material is increased in the positive electrode 21. This increases the energy density of the positive electrode 21, as well as making the charge-discharge reaction based on deposition/dissolution of magnesium more likely to proceed in a stable manner. Accordingly as described previously, the electrochemical state of the positive electrode 21 during charge-discharge of the secondary battery will improve, whereby high battery capacity will be obtainable making use of deposition/dissolution of magnesium.

The trimagnesium disulfide-containing compound herein is a discharge product specifically formed by discharging a secondary battery having a predetermined structure. The trimagnesium disulfide-containing compound will therefore not be formed, even if any secondary battery not having a predetermined structure is allowed to discharge. Details of the predetermined structure of the secondary battery mentioned herein will be described later.

The sulfur-containing material further preferably contains magnesium sulfide (MgS) in the discharged state. That is, the sulfur-containing material preferably contains magnesium sulfide in the discharged state, together with trimagnesium disulfide. This is because the charge-discharge reaction based on deposition/dissolution of magnesium will be more likely to proceed stably, whereby a higher battery capacity will be obtainable.

It is particularly preferred that magnesium sulfide has a zinc blende-type crystal structure, although the crystal structure of magnesium sulfide is not particularly limited. This is because the charge-discharge reaction based on deposition/dissolution of magnesium will be more likely to proceed stably, whereby an even much higher battery capacity will be obtainable. Procedures for confirming the crystal structure of magnesium sulfide will be described later.

The positive electrode 21 may have the positive electrode current collector 21A and the positive electrode active material layer 21B, as illustrated in FIG. 3. This is because the positive electrode 21 will have improved performance of current collection, whereby high battery capacity is obtainable stably. The positive electrode current collector 21A may, however, be omissible.

The positive electrode current collector 21A is a conductive member that supports the positive electrode active material layer 21B, and has a pair of faces on which the positive electrode active material layer 21B is provided. The positive electrode current collector 21A contains one kind of, or two or more kinds of conductive materials such as metal material. Specific examples of the conductive materials include nickel and stainless steel.

The positive electrode active material layer 21B is supported by the positive electrode current collector, and contains any one kind of, or two or more kinds of the sulfur-containing materials as the positive electrode active material. The positive electrode active material layer 21B may further contain any one kind of, or two or more kinds of other materials such as positive electrode binder and positive electrode conductive agent.

The positive electrode active material layer 21B may be provided on both faces of the positive electrode current collector 21A, or may be provided only on one face of the positive electrode current collector 21A. FIG. 3 illustrates the positive electrode active material layers 21B provided on both faces of the positive electrode current collector 21A. Method of forming the positive electrode active material layer 21B is not particularly limited, and may be one kind of, or two or more kinds of method including coating.

The positive electrode binder contains any one kind of, or two or more kinds of resin materials including fluororesin, polyvinyl alcohol-based resin, and styrene-butadiene copolymer rubber. Specific examples of the fluororesin include polyvinylidene fluoride and polytetrafluoroethylene.

The positive electrode binder may alternatively be a conductive polymer compound. Specific examples of the conductive polymer compound include polyaniline, polypyrrole, and polythiophene, where also copolymer of two or more species thereof is acceptable. The conductive polymer compound may be unsubstituted, or may be substituted with any one kind of, or two or more kinds of functional group.

The positive electrode conductive agent contains any one kind of, or two or more kinds of conductive materials including carbon material, a metal material, and a conductive polymer compound.

Examples of the carbon material include graphite, carbon fiber, carbon black, and carbon nanotube. Specific examples of the graphite include natural graphite and artificial graphite. Specific examples of the carbon fiber include vapor grown carbon fiber (VGCF). Specific examples of the carbon black include acetylene black and Ketjen black. Specific examples of the carbon nanotube include single-walled carbon nanotube (SWCNT) and multi-walled carbon nanotube (MWCNT). Specific examples of the multi-walled carbon nanotube include double-walled carbon nanotube (DWCNT). Specific examples of the metal material include nickel.

It is preferred, but not particularly restrictively, that the areal density (mg/cm²) of the sulfur-containing material in the positive electrode active material layer 21B is sufficiently large. This is because the trimagnesium disulfide-containing compound will be more likely to be formed in the discharged state.

The areal density means the weight (mg) of the sulfur-containing material per unit area (cm²) of the positive electrode active material layer 21B, and more specifically, the weight of the sulfur-containing material per area of the positive electrode active material layer 21B facing the negative electrode 22.

Sufficient largeness of the areal density of the sulfur-containing material described herein is one of predetermined structures of the secondary battery necessary for forming the aforementioned trimagnesium disulfide-containing compound as the discharge product.

More specifically, the areal density of the sulfur-containing material is preferably 1 mg/cm² to 10 mg/cm². This is because the trimagnesium disulfide-containing compound will be more likely to be formed.

With the areal density of the sulfur-containing material adjusted to 1 mg/cm² to 10 mg/cm², the capacity of the positive electrode 21 will increase, and more specifically, the capacity of the positive electrode 21 will become 1 mAh/cm² or larger.

Procedures for estimating the areal density of the sulfur-containing material are as described below. The paragraphs below will describe a case where the positive electrode active material layers 21B are provided on both faces of the positive electrode current collector 21A.

First, the secondary battery is disassembled to take out the positive electrode 21. Whether the secondary battery in this case has been discharged or not, is not limitative. Next, the positive electrode 21 is cleaned with a cleaning solvent to remove the electrolytic solution adhered thereto. The kind of the cleaning solvent is specifically, but not particularly restrictively, any one kind of, or two or more kinds of nonaqueous solvents such as ethyl-n-propylsulfone, dimethoxyethane, and dimethyl carbonate.

Next, the size of either one of the two positive electrode active material layers 21B is measured, to estimate the area (cm²) of the positive electrode active material layer 21B. In one exemplary case where the positive electrode active material layer 21B is given a rectangular shape, the length (cm) and the width (cm) of the positive electrode active material layer 21B are measured, with which the area (=length×width) is estimated.

Next, the positive electrode active material layer 21B, whose area has been estimated, is analyzed by an analytical method such as inductively coupled plasma (ICP) emission spectrometry, to estimate the weight (mg) of sulfur atoms contained in the positive electrode active material layer 21B.

Lastly, the areal density of the sulfur-containing material is estimated according to an equation: Areal density (mg/cm²)=Weight of sulfur atom (mg)/Area of positive electrode active material layer 21B (cm²).

The negative electrode 22 contains any one kind of, or two or more kinds of the magnesium-containing material as the negative electrode active material. This is because the charge-discharge reaction based on deposition/dissolution of magnesium will be more likely to proceed.

The magnesium-containing material herein is a collective term for materials that contain magnesium as a constituent element, as described previously. The magnesium-containing material may, therefore, be elemental magnesium, magnesium alloy, magnesium compound, or mixture of two or more of these species. The elemental magnesium, whose purity is not particularly limited, may contain an unspecified amount of impurity.

The kind of metal element (exclusive of magnesium) contained as the constituent element in the magnesium alloy is not particularly limited, and may be any one kind of, or two or more kinds of unspecified metal elements. The magnesium compound contains any one kind of, or two or more kinds of nonmetallic elements such as carbon, oxygen, sulfur, and halogen as the constituent element. Specific examples of the halogen include fluorine, chlorine, bromine, and iodine.

In particular, the magnesium-containing material preferably contains elemental magnesium. This is because the charge-discharge reaction based on deposition/dissolution of magnesium can fully proceed.

The negative electrode 22 may have a structure similar to that of the positive electrode 21. That is, the negative electrode 22 may contain a negative electrode current collector, and a negative electrode active material layer, although not specifically illustrated herein.

The negative electrode current collector is a conductive member that supports the negative electrode active material layer, and has a pair of faces on which the negative electrode active material layer is provided. The negative electrode current collector contains one kind of, or two or more kinds of conductive materials such as metal material. Specific examples of the conductive materials include nickel and stainless steel.

The negative electrode active material layer is supported by the negative electrode current collector, and contains any one kind of, or two or more kinds of the magnesium-containing materials as the negative electrode active material. The negative electrode active material layer may further contain any one kind of, or two or more kinds of other materials such as negative electrode binder and negative electrode conductive agent.

The negative electrode active material layer may be provided on both faces of the negative electrode current collector, or may be provided only on one face of the negative electrode current collector. Method of forming the negative electrode active material layer is not particularly limited, and may be one kind of, or two or more kinds of method including coating.

Details regarding the negative electrode binder are the same as the details regarding the positive electrode binder, and details regarding the negative electrode conductive agent are the same as the details regarding the positive electrode conductive agent.

The separator 23 illustrated in FIGS. 2 and 3 is an insulating porous film interposed between the positive electrode 21 and the negative electrode 22, and allows magnesium to pass therethrough while preventing a short-circuiting between the positive electrode 21 and the negative electrode 22. The separator 23 contains a polymer compound such as polyethylene.

The electrolytic solution is a liquid electrolyte, and contains a solvent and an electrolyte salt.

The solvent contains any one kind of, or two or more kinds of nonaqueous solvents (organic solvents). The electrolytic solution that contains the nonaqueous solvent is a so-called nonaqueous electrolytic solution. The nonaqueous solvent, although the type thereof is not particularly limited, is preferably capable of promoting formation of the trimagnesium disulfide-containing compound during discharge of the secondary battery.

Capability of the nonaqueous solvent described herein, promoting formation of the trimagnesium disulfide-containing compound, is one of predetermined structures of the secondary battery necessary for forming the aforementioned trimagnesium disulfide-containing compound.

More specifically, the nonaqueous solvent contains either one or both of dialkylsulfone and ether compound. This is because, the trimagnesium disulfide-containing compound will be more likely to be formed during discharge of the secondary battery. The dialkylsulfone may be of a single type, or of two or more types. Similarly, the ether compound may be of a single type, or of two or more types.

Dialkylsulfone is a compound represented by formula (1). Kinds of R1 and R2 may be the same, or different.

$$R 1 - {S ( = O )}_{2} - R 2 \qquad ( 1 )$$

(Each of R1 and R2 represents an alkyl group.)

Kind of the alkyl group is not particularly limited. The alkyl group may therefore be straight or branched. The number of carbon atoms in the alkyl group is particularly preferably four or smaller, although not specifically limited. Specific examples of the alkyl group include methyl group, ethyl group, n-propyl group, i-propyl group, n-butyl group, i-butyl group, s-butyl group, and t-butyl group.

Specific examples of dialkylsulfone include dimethylsulfone, methylethylsulfone, methyl-n-propylsulfone, methyl-1-propylsulfone, methyl-n-butylsulfone, methyl-1-butylsulfone, methyl-s-butylsulfone, methyl-t-butylsulfone, ethylmethylsulfone, diethylsulfone, ethyl-n-propylsulfone, ethyl-1-propylsulfone, ethyl-n-butylsulfone, ethyl-1-butylsulfone, ethyl-s-butylsulfone, ethyl-t-butylsulfone, di-n-propylsulfone, di-i-propylsulfone, n-propyl-n-butylsulfone, n-butylethylsulfone, i-butylethylsulfone, s-butylethylsulfone, and di-n-butylsulfone.

Among them, dialkylsulfone is preferably ethyl-n-propylsulfone, ethyl-1-propylsulfone, or the like. This is because, the trimagnesium disulfide-containing compound will be sufficiently formed, when the secondary battery is allowed to discharge.

The ether compound is a collective term for compounds having ether bond (—O—). The ether compound may be chain-like or cyclic. The number of ether bonds may be one, or two or larger.

Specific examples of the ether compound include dimethoxyethane, diethylene glycol dimethyl ether, tetraethylene glycol dimethyl ether, and tetrahydrofuran.

The electrolyte salt contains any one kind of, or two or more kinds of magnesium salts. This is because the charge-discharge reaction based on deposition/dissolution of magnesium can fully proceed.

The magnesium salt, although the type thereof is not particularly limited, is preferably capable of promoting formation of the trimagnesium disulfide-containing compound during the discharge of the secondary battery. Capability of the magnesium salt described herein, such as promoting formation of the trimagnesium disulfide-containing compound, is one of predetermined structures of the secondary battery necessary for forming the aforementioned trimagnesium disulfide-containing compound.

Specific examples of the magnesium salt include magnesium chloride (MgCl₂) and magnesium bis(trifluoromethanesulfonyl)imide (Mg[N(CF₃SO₂)₂]₂). This is because, the trimagnesium disulfide-containing compound will be sufficiently formed, when the secondary battery is allowed to discharge.

The electrolyte salt may further contain any one kind of, or two or more kinds of other magnesium salts. Specific examples of such other magnesium salts include magnesium perchlorate (Mg(ClO₄)₂), magnesium nitrate (Mg(NO₃)₂), magnesium sulfate (MgSO₄), magnesium acetate (Mg(CH₃COO)₂), magnesium trifluoroacetate (Mg(CF₃COO)₂), magnesium tetrafluoroborate (Mg(BF₄)₂), magnesium tetraphenylborate (Mg(B(C₆H₅)₄)₂), magnesium hexafluorophosphate (Mg(PF₆)₂), magnesium hexafluoroarsenate (Mg(AsF₆)₂), bis(hexamethyldisilazide) magnesium (Mg[N(Si(CH₃)₃)₂]₂), and bis[tetra(hexafluoroisopropyl)]magnesium borate (Mg[B(OCH(CF₃)₂)_{4]2}).

The content (mol/l (=mol/dm³)) of the electrolyte salt in the electrolytic solution is not particularly limited, and may be set freely. Note the content of the electrolyte salt described herein is the content of the electrolyte salt with respect to the solvent.

As illustrated in FIGS. 1 to 3, the positive electrode lead 31 is a positive electrode interconnect connected to the positive electrode 21, and is led out to the outside of the exterior film 10. In a case where the positive electrode 21 has the positive electrode current collector 21A, the positive electrode lead 31 is connected to the positive electrode current collector 21A. The positive electrode lead 31 contains a conductive material such as metal material. Specific example of the conductive material is any one kind of, or two or more kinds of metal materials such as nickel and stainless steel. The form of the positive electrode lead 31 is any of thin strip, mesh, and the like.

As illustrated in FIGS. 1 to 3, the negative electrode lead 32 is a negative electrode interconnect connected to the negative electrode 22, and is led out to the outside of the exterior film 10. In a case where the negative electrode 22 has the negative electrode current collector, the negative electrode lead 32 is connected to the negative electrode current collector. The lead-out direction of the negative electrode lead 32 is specifically the same as the lead-out direction of the positive electrode lead 31, although not particularly limited. The negative electrode lead 32 contains a conductive material such as metal material. Specific example of the conductive material is any one kind of, or two or more kinds of metal materials such as copper. Details of the form of the negative electrode lead 32 are the same as those of the form of the positive electrode lead 31.

The sealing film 41 is interposed between the exterior film 10 and the positive electrode lead 31, meanwhile the sealing film 42 is interposed between the exterior film 10 and the negative electrode lead 32. Note either one of, or both of the sealing films 41 and 42 are omissible.

The sealing film 41 is a sealing member that prevents outside air or the like from entering the inside of the exterior film 10. The sealing film 41 contains a polymer compound such as polyolefin which is adhesive to the positive electrode lead 31. Specific examples of the polymer compound include polypropylene.

The structure of the sealing film 42 is the same as the structure of the sealing film 41, except being a sealing member which is adhesive to the negative electrode lead 32. That is, the sealing film 42 contains a polymer compound such as polyolefin which is adhesive to the negative electrode lead 32.

The positive electrode 21 has the predetermined physical properties.

FIG. 4 illustrates an exemplary result of analysis (result of ²⁵Mg-NMR analysis) of the positive electrode 21, in order to explain results of analysis of the positive electrode 21 by magnesium-25 nuclear magnetic resonance spectroscopy (²⁵Mg-NMR). In FIG. 4, the abscissa represents the chemical shift (ppm), and the ordinate represents the intensity (arbitrary unit).

As described previously, the positive electrode 21 in the undischarged state contains the sulfur-containing material as the positive electrode active material, and the sulfur-containing material in the discharged state contains the trimagnesium disulfide-containing compound as the discharge product. The trimagnesium disulfide-containing compound contains trimagnesium disulfide, as described previously. Therefore, by analyzing the positive electrode 21 in the discharged state by ²⁵Mg-NMR to investigate the physical properties of the positive electrode 21, the positive electrode 21 will be found to have the predetermined physical properties.

In a case where the positive electrode 21 has the positive electrode current collector 21A and the positive electrode active material layer 21B, the positive electrode active material layer 21B in the discharged state is analyzed by ²⁵Mg-NMR.

Analysis of the positive electrode 21 by ²⁵Mg-NMR is conducted with use of a nuclear magnetic resonance spectrometer, which is a 800 MHz solid-state nuclear magnetic resonance spectrometer (measurement magnetic field intensity=18.79 T), from JEOL Ltd., equipped with a magic angle spinning (MAS) probe (diameter=3.2 mm).

Analysis conditions include: resonance frequency=49.00 MHz, observation range=294 kHz, MAS rotation speed=15 kHz, chemical shift standard=aqueous MgCl₂ solution (0 ppm), measurement pulse sequence=single pulse method, measurement pulse width=1.3 μs (30° pulse), repetition time=1 second, and number of scans=approx. 80,000.

More specifically, the sulfur-containing material in the discharged state contains sulfur and magnesium as the constituent elements. The reason why the sulfur-containing material in the discharged state contains not only sulfur but also magnesium as the constituent elements is that magnesium dissolved in the negative electrode 22 is occluded in the positive electrode 21, as described previously.

In this case, the result of analysis of the positive electrode 21 by ²⁵Mg-NMR is obtainable as an NMR spectrum 4A as illustrated in FIG. 4. Since the positive electrode 21 contains the trimagnesium disulfide-containing compound as described previously, a peak P1 (first peak) is detected in the NMR spectrum 4A, within a range of chemical shift from −70 ppm to 0 ppm. In FIG. 4, the range of chemical shift from −70 ppm to 0 ppm is shaded.

The peak P1 is detected due to presence of the trimagnesium disulfide-containing compound, and may be used to confirm the presence or absence of the trimagnesium disulfide-containing compound.

As described previously, the trimagnesium disulfide-containing compound is a discharge product formed by discharge of the secondary battery having the predetermined structure. Therefore, the NMR spectrum 4A having the peak P1 as illustrated in FIG. 4 is obtainable, by allowing the secondary battery having the predetermined structure to discharge, and by analyzing the positive electrode 21 in the discharged state by ²⁵Mg-NMR.

In contrast, an NMR spectrum 4B, in place of the NMR spectrum 4A, is obtainable as illustrated in FIG. 4, by allowing a secondary battery not having the predetermined structure to discharge. In this case, the trimagnesium disulfide-containing compound will not be formed, and the peak P1 will therefore not be detected.

Thus, if there were the trimagnesium disulfide-containing compound formed as the discharge product, in the discharged state, the NMR spectrum 4A is obtainable, with the peak P1 detectable therein. On the other hand, if there were no trimagnesium disulfide-containing compound formed as the discharge product, in the discharged state, the NMR spectrum 4B is obtainable, with the peak P1 not detectable therein. Whether or not the sulfur-containing material in the positive electrode 21 contains the trimagnesium disulfide-containing compound can therefore be confirmed, according to whether or not the peak P1 is detected.

Note FIG. 4 depicts the NMR spectrum 4A with a solid line, and depicts the NMR spectrum 4B with a broken line, for easy distinction between the NMR spectra 4A and 4B. Also note FIG. 4 illustrates position of the NMR spectrum 4A and position of the NMR spectrum 4B while being vertically shifted without causing overlapping, for easy recognition of the NMR spectra 4A and 4B.

In the NMR spectrum 4A, the area density of the sulfur-containing material in the positive electrode 21 is found to be 3 mg/cm³, meanwhile in the NMR spectrum 4B, the area density of the sulfur-containing material in the positive electrode 21 is found to be 0.6 mg/cm³.

Peak count of the peak P1 herein is not particularly limited. The peak count of the peak P1 may therefore be only one, or two or larger.

Peak shape of the peak P1 is not particularly limited. The peak shape of the peak P1 may therefore be sharp or broad. In a case where there are two or more peaks P1, it is acceptable that some of the peaks P1 have sharp shape, and the residual peaks P1 have broad shape.

Note in a case where there are two or more peaks P1, the two or more peaks P1 may occasionally overlap and therefore seem to be broad, depending on resolution of the analysis.

The sulfur-containing material further preferably contains magnesium sulfide in the discharged state, as described previously. Since the positive electrode 21 contains the magnesium sulfide, the NMR spectrum 4A illustrated in FIG. 4 then preferably has a peak P2 (second peak) detected within a range of chemical shift from 60 ppm to 80 ppm. In FIG. 4, the range of chemical shift from 60 ppm to 80 ppm is shaded.

The peak P2 is detected due to presence of magnesium sulfide, and may be used to confirm the presence or absence of magnesium sulfide.

Unlike the trimagnesium disulfide-containing compound which is a discharge product, magnesium sulfide is formed as a result of discharge of the secondary battery whose positive electrode 21 contains the sulfur-containing material, regardless of whether or not the secondary battery has the predetermined structure. Therefore, the NMR spectrum 4A having the peak P1 as well as the peak P2 as illustrated in FIG. 4 is obtainable, by allowing the secondary battery whose positive electrode 21 contains the sulfur-containing material to discharge, and by analyzing the positive electrode 21 in the discharged state by ²⁵Mg-NMR.

Since the positive electrode 21 contains magnesium sulfide, the peak P2 is then similarly detected also in the NMR spectrum 4B as illustrated in FIG. 4.

That is, the NMR spectrum 4A or the NMR spectrum 4B is obtainable in the discharged state, if the positive electrode 21 contains the sulfur-containing material. Accordingly, the peak P2 is detected in both the NMR spectrum 4A and the NMR spectrum 4B. Whether or not the sulfur-containing material in the positive electrode 21 contains magnesium sulfide can therefore be confirmed, according to whether or not the peak P2 is detected.

As illustrated in FIG. 4, the peak P1 has intensity I1, and the peak P2 has intensity I2, in the NMR spectrum 4A. The intensity I1 is the maximum intensity of the peak P1, meanwhile the intensity I2 is the maximum intensity of the peak P2.

Peak intensity ratio herein, which is the ratio of the intensity I1 to the intensity I2, is not particularly limited. In particular, the peak intensity ratio is preferably 0.05 or larger. This is because the relationship between the intensity I1 and the intensity I2 will be well balanced, so that a high battery capacity is obtainable in a stable manner. The peak intensity ratio is estimated based on an equation: Peak intensity ratio=I1/I2.

When determining each of the intensities I1 and I2, a baseline BL is drawn as illustrated in FIG. 4, making use of a calculation function installed on the nuclear magnetic resonance spectrometer. A maximum intensity value of the peak P1 is measured with reference to the baseline BL, to determine the intensity I1. Also a maximum intensity value of the peak P2 is measured with reference to the baseline BL, to determine the intensity I2.

As described previously, the peak P1 is detected in the NMR spectrum 4A as a result of analysis of the positive electrode 21 by ²⁵Mg-NMR, whereby the sulfur-containing material is confirmed to contain the trimagnesium disulfide-containing compound in the discharged state. Since the trimagnesium disulfide-containing compound is identified according to the detection of the peak P1 in the result of ²⁵Mg-NMR analysis, it is confirmed that the trimagnesium disulfide-containing compound is formed as the discharge product during discharge of the secondary battery.

The reason why the trimagnesium disulfide-containing compound is identified according to the detection of the peak P1 is as follows.

Herein, a stable structure composed of magnesium (Mg) and sulfur(S) is predicted with use of the first-principles calculation. This matches the position (range of chemical shift) of the NMR parameter predicted for the structure of trimagnesium disulfide, with the position (range of chemical shift) of the peak P1 detected in the NMR spectrum 4A as a result of analysis by ²⁵Mg-NMR. It is therefore judged that the trimagnesium disulfide-containing compound was identified, according to the detection of the peak P1.

The peak P1 detected in the NMR spectrum 4A as a result of analysis by ²⁵Mg-NMR is a peak uniquely detected due to the trimagnesium disulfide-containing compound. Accordingly, detection of the peak P1 in the NMR spectrum 4A within a range of chemical shift from −70 ppm to 0 ppm indicates that the trimagnesium disulfide-containing compound is present in the sulfur-containing material in the discharged state.

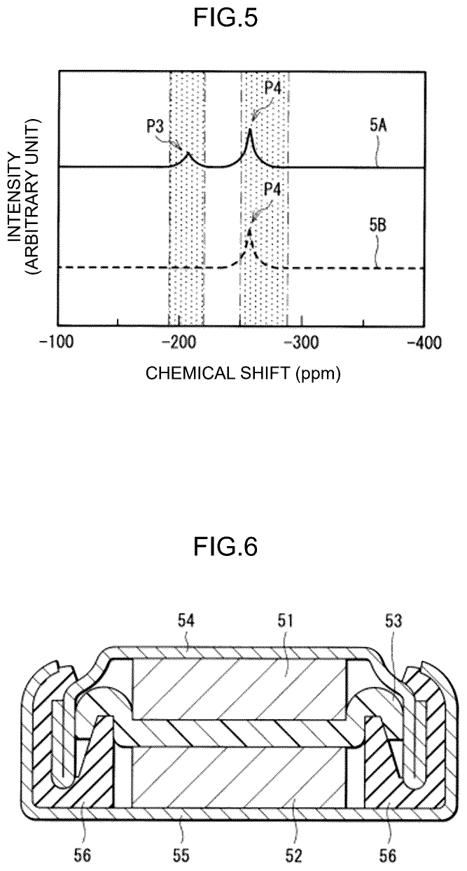

FIG. 5 illustrates an exemplary result of analysis (result of ³³S-NMR analysis) of the positive electrode 21, in order to explain results of analysis of the positive electrode 21 by sulfur-33 nuclear magnetic resonance spectroscopy (³³S-NMR), and corresponds to FIG. 4. Also in this case of using the result of analysis by ³³S-NMR, the sulfur-containing material can be confirmed to contain the trimagnesium disulfide-containing compound in the discharged state, similarly to the case of using the result of analysis by ²⁵Mg-NMR.

The main component of natural sulfur is sulfur-32. Accordingly, the analysis of the positive electrode 21 by ³³S-NMR uses the sulfur-containing material, whose raw material is sulfur-33, to analyze the trimagnesium disulfide-containing compound obtainable from such sulfur-containing material in the discharged state.

Analysis of the positive electrode 21 by ³³S-NMR is conducted with use of a nuclear magnetic resonance spectrometer, which is a 800 MHz solid-state nuclear magnetic resonance spectrometer (measurement magnetic field intensity=18.79 T), from JEOL Ltd., equipped with a magic angle spinning (MAS) probe (diameter=3.2 mm).

Analysis conditions include: resonance frequency=61.42 MHz, observation range=123 kHz, MAS rotation speed=15 kHz, chemical shift standard=calcium sulfide (−29 ppm), measurement pulse sequence=single pulse method, measurement pulse width=1 μs (30° pulse), repetition time=0.5 second, and number of scans=approx. 160,000.

Specifically, the result of analysis of the positive electrode 21 by ³³S-NMR is obtainable as an NMR spectrum 5A as illustrated in FIG. 5. Since the positive electrode 21 contains the trimagnesium disulfide-containing compound, a peak P3 is detected in the NMR spectrum 5A, within a range of chemical shift from −220 ppm to −190 ppm. In FIG. 5, the range of chemical shift from −220 ppm to −190 ppm is shaded. The peak P3 is detected due to the presence of the trimagnesium disulfide-containing compound, similarly to the peak P1.

In contrast, an NMR spectrum 5B, in place of the NMR spectrum 5A, is obtainable as illustrated in FIG. 5, in a case where the positive electrode 21 does not contain the trimagnesium disulfide-containing compound. In this case, the trimagnesium disulfide-containing compound will not be formed, and the peak P3 will therefore not be detected. Whether or not the sulfur-containing material in the positive electrode 21 contains the trimagnesium disulfide-containing compound can therefore be confirmed, according to whether or not the peak P3 is detected.

Note FIG. 5 depicts the NMR spectrum 5A with a solid line, and depicts the NMR spectrum 5B with a broken line, and illustrates the position of the NMR spectrum 5A and position of the NMR spectrum 5B while being vertically shifted, similarly to in FIG. 4.

In a case where the sulfur-containing material further contains magnesium sulfide in the discharged state, as illustrated in FIG. 5, a peak P4 is detected in the NMR spectrum 5A, within a range of chemical shift from −280 ppm to −250 ppm. In FIG. 5, the range of chemical shift from −280 ppm to −250 ppm is shaded. The peak P4 is detected due to the presence of magnesium sulfide.

Since the positive electrode 21 contains magnesium sulfide, the peak P4 is then similarly detected also in the NMR spectrum 5B as illustrated in FIG. 5. Whether or not the sulfur-containing material in the positive electrode 21 contains magnesium sulfide can therefore be confirmed, according to whether or not the peak P4 is detected.

As described previously, the peak P3 is detected in the NMR spectrum 5A as a result of analysis of the positive electrode 21 by ³³S-NMR, whereby the sulfur-containing material is confirmed to contain the trimagnesium disulfide-containing compound in the discharged state. Thus, the trimagnesium disulfide-containing compound is identified according to the detection of the peak P3 in the result of analysis by ³³S-NMR.

In this case, as described previously, a stable structure composed of magnesium and sulfur is predicted by the first-principles calculation. This matches the position of the NMR parameter predicted for the structure of trimagnesium disulfide, with the position of the peak P3 detected in the NMR spectrum 5A as a result of analysis by 33S-NMR. Thus, the trimagnesium disulfide-containing compound is identified according to the detection of the peak P3.

Accordingly, the sulfur-containing material, whose raw material is sulfur-33, is used to analyze the trimagnesium disulfide-containing compound obtainable from such sulfur-containing material in the discharged state. This matches each of the peak P1 detected in the result of analysis by ²⁵Mg-NMR, and the peak P3 detected in the result of analysis by ³³S-NMR, with a peak of trimagnesium disulfide predicted by the first-principles calculation, whereby the trimagnesium disulfide-containing compound is identified.

In a case where the sulfur-containing material in the discharged state contains magnesium sulfide, procedures for confirming the crystal structure of the magnesium sulfide are as follows. The description herein will be made on a case where the positive electrode 21A has the positive electrode current collector 21 and the positive electrode active material layer 21B.

First, the secondary battery is allowed to discharge, then disassembled to take out the positive electrode 21. Next, the positive electrode 21, remained uncleaned, is dried in vacuo, so as to vaporize off the electrolytic solution adhered to the positive electrode 21. A sample to be analyzed (positive electrode 21) is thus obtained.

Next, the sample (diameter=3.2 mm) is placed into a sample tube, and the sample (positive electrode active material layer 21B) is then analyzed by solid-state magnesium-25 nuclear magnetic resonance spectroscopy (solid-state ²⁵Mg-NMR) to obtain a result of analysis of the sample (result of solid-state ²⁵Mg-NMR analysis).

The nuclear magnetic resonance spectrometer used in this case is a 800 MHz solid-state nuclear magnetic resonance spectrometer (measurement magnetic field intensity=18.79 T) from JEOL Ltd. The sample tube is set on a magic angle spinning (MAS) probe (diameter=3.2 mm) attached to the 800 MHz solid-state nuclear magnetic resonance spectrometer.

Analysis conditions include: resonance frequency=49.00 MHz, observation range=294 kHz, MAS rotation speed=15 kHz, chemical shift standard=aqueous MgCl₂ solution (0 ppm), measurement pulse sequence=single pulse method, measurement pulse width=1.3 μs (30° pulse), repetition time=1 second, and number of scans=approx. 80,000.

Lastly, the crystal structure of magnesium sulfide is determined, according to the result of analysis by solid-state ²⁵Mg-NMR.

More specifically, if a peak is detected within a range of chemical shift from 60 ppm to 80 ppm, magnesium sulfide has a zinc blende-type crystal structure. In contrast, if no peak is detected within a range of chemical shift from 60 ppm to 80 ppm, magnesium sulfide does not have the zinc blende-type crystal structure. Whether or not magnesium sulfide has a zinc blende-type crystal structure can therefore be confirmed, according to whether or not the peak described herein is detected.

Note that if a peak is detected within a range of chemical shift from −10 ppm to 10 ppm, magnesium sulfide has a rocksalt-type crystal structure. In contrast, if no peak is detected within a range of chemical shift from −10 ppm to 10 ppm, magnesium sulfide does not have a rocksalt-type crystal structure. Whether or not magnesium sulfide has a rocksalt-type crystal structure can therefore be confirmed, according to whether or not the peak described herein is detected.

The battery element 20 of the secondary battery operates as follows.

During discharging, the magnesium-containing material dissolves in the negative electrode 22, whereby magnesium is eluted into the electrolytic solution. This causes the positive electrode 21 to occlude magnesium.

Since the trimagnesium disulfide-containing compound is thus formed in the positive electrode 21 after the secondary battery is allowed discharge, the sulfur-containing material in the discharged state will contain magnesium disulfide.

On the other hand, during charging, magnesium is released from the positive electrode 21 into the electrolytic solution. This causes magnesium to deposit in the negative electrode 22.

Since the trimagnesium disulfide-containing compound thus disappears from the positive electrode 21 after the secondary battery is charged, the sulfur-containing material therefore does not contain magnesium disulfide in the undischarged state.

Repetitive charge-discharge of the secondary battery alternates the aforementioned discharge reaction and the charge reaction, whereby formation and disappearance of the trimagnesium disulfide-containing compound are repeated. The trimagnesium disulfide-containing compound is therefore a reversible discharge product in which formation and disappearance are repetitively caused following the charge-discharge of the secondary battery.

The secondary battery is manufactured, making use of an exemplary procedure described below.

The paragraphs below will describe a case where elemental sulfur (sulfur powder) is used as the sulfur-containing material, and elemental magnesium (metallic magnesium) is used as the magnesium-containing material. The description herein will also be made on a case where the positive electrode 21 has the positive electrode current collector 21A and the positive electrode active material layer 21B.

First, a positive electrode active material (sulfur powder as the sulfur-containing material), a positive electrode binder, and a positive electrode conductive agent are mixed, to obtain a positive electrode mixture. Next, the positive electrode mixture is placed in a solvent, to prepare a pasty positive electrode mixture slurry. The solvent herein may be an aqueous solvent or an organic solvent. Lastly, the positive electrode mixture slurry is applied to both faces of the positive electrode current collector 21A, to form the positive electrode active material layer 21B. Thereafter, the positive electrode active material layer 21B may be compression-molded, with use of a compression apparatus such as a roll press machine. The positive electrode active material layer 21B in this case may be heated, or may be compression-molded a plurality of times. In this way, the positive electrode active material layers 21B are formed on both faces of the positive electrode current collector 21A, and the positive electrode 21 is thus manufactured.

When manufacturing the positive electrode 21, it is preferred to sufficiently increase the areal density of the sulfur-containing material, in order to promote formation of the trimagnesium disulfide-containing compound as a discharge product, when the thus completed secondary battery is allowed to discharge, as described previously.

A negative electrode active material (metallic magnesium as the magnesium-containing material) is prepared for the negative electrode 22. The metallic magnesium used herein is magnesium foil.

An electrolyte salt is placed into a solvent. This causes the electrolyte salt to dissolve or disperse in the solvent, whereby an electrolytic solution is prepared.

When preparing the electrolytic solution, it is preferred to use a specific kind of solvent, as well as to use a specific kind of electrolyte salt, in order to promote formation of the trimagnesium disulfide-containing compound as a discharge product, when the thus completed secondary battery is allowed to discharge, as described previously.

More specifically, it is preferred to use non-aqueous solvent such as dialkylsulfone and ether compound, as the solvent. It is also preferred to use magnesium salt such as magnesium chloride or magnesium bis(trifluoromethanesulfonyl)imide, as the electrolyte salt.

First, the positive electrode lead 31 is bonded to the positive electrode 21 by a bonding method such as welding, and the negative electrode lead 32 is bonded to the negative electrode 22 by a bonding method such as welding. In this case, the positive electrode lead 31 is bonded to the positive electrode current collector 21A.

Next, the positive electrode 21 and the negative electrode 22 are stacked while placing the separator 23 in between, and then the positive electrode 21, the negative electrode 22, and the separator 23 are rolled to form a roll (not illustrated). Next, the roll is pressed with use of a compression apparatus such as a pressing machine, to shape the roll into an oblate shape. The thus shaped roll has the same structure as that of the battery element 20, except that each of the positive electrode 21, the negative electrode 22, and the separator 23 is not yet impregnated with the electrolytic solution.

Next, the roll is accommodated in the recess 10U, the exterior film 10 (melt-bonding layer/metal layer/surface protective layer) is folded, to make the exterior film 10 abutted. Next, the outer peripheral edges along two sides of the melt-bonding layer are mutually bonded by a bonding method such as thermal bonding, whereby the roll is accommodated in the pouch-like exterior film 10.

Lastly, the electrolytic solution is injected into the pouch-like exterior film 10, and the peripheral edges along one residual side from among the opposing sides of the melt-bonding layer are mutually bonded by a bonding method such as thermal bonding. In this case, the sealing film 41 is interposed between the exterior film 10 and the positive electrode lead 31, meanwhile the sealing film 42 is interposed between the exterior film 10 and the negative electrode lead 32.

The roll is thus impregnated with the electrolytic solution, whereby the battery element 20 which is a rolled electrode body is formed. The battery element 20 is thus enclosed in the bag-shaped exterior film 10, whereby the secondary battery is completed.

In this secondary battery, the positive electrode 21 includes the sulfur-containing material, the negative electrode 22 includes the magnesium-containing material, wherein the sulfur-containing material includes trimagnesium disulfide as the trimagnesium disulfide-containing compound in the discharged state.

In this case, the amount of occlusion of magnesium in the sulfur-containing material increases, making use of the property of trimagnesium disulfide, as described previously. Moreover, owing to the property of trimagnesium disulfide, the positive electrode 21 will be suppressed from increasing the electrical resistance, even if the areal density of the sulfur-containing material is increased in the positive electrode 21. This increases the energy density of the positive electrode 21, as well as making the charge-discharge reaction based on deposition/dissolution of magnesium more likely to proceed in a stable manner. A high battery capacity will therefore be obtainable making use of deposition/dissolution of magnesium, whereby excellent battery characteristic will be obtainable.

In particular, if the sulfur-containing material further includes magnesium sulfide in the discharged state, the charge-discharge reaction based on deposition/dissolution of magnesium will proceed in a sufficiently stable manner, whereby a higher effect will be obtainable.

In this case, if magnesium sulfide has a zinc blende-type crystal structure, the charge-discharge reaction based on deposition/dissolution of magnesium will proceed more stably, whereby a higher effect will be obtainable.

If the sulfur-containing material includes elemental sulfur, the charge-discharge reaction based on deposition/dissolution of magnesium will sufficiently proceed, whereby a higher effect will be obtainable.

If the positive electrode 21 has the positive electrode active material layer 21B, and the areal density of the sulfur-containing material in the positive electrode active material layer 21B is adjusted to 1 mg/cm² to 10 mg/cm², trimagnesium disulfide will be more likely to be formed sufficiently, whereby a higher effect will be obtainable.

If in the electrolytic solution, the solvent includes either or both of dialkylsulfone and an ether compound, as well as the electrolyte salt includes the magnesium salt, trimagnesium disulfide will be more likely to be formed when the secondary battery is allowed to discharge, whereby a higher effect will be obtainable.

If the magnesium-containing material includes elemental magnesium, the charge-discharge reaction based on deposition/dissolution of magnesium will sufficiently proceed, whereby a higher effect will be obtainable.

If the secondary battery is a magnesium-sulfur secondary battery, a sufficient battery capacity will be obtainable making use of deposition/dissolution of magnesium, whereby a higher effect will be obtainable.

In addition, the positive electrode 21 includes the sulfur-containing material, the negative electrode 22 includes the magnesium-containing material, the sulfur-containing material includes sulfur and magnesium as constituent elements in the discharged state, and the positive electrode 21 in the discharged state demonstrates a peak P1, in a result of analysis by ²⁵Mg-NMR.

Accordingly, the energy density of the positive electrode 21 will increase, and the charge-discharge reaction based on deposition/dissolution of magnesium will be more likely to proceed stably, for the reasons above. A high battery capacity will therefore be obtainable making use of deposition/dissolution of magnesium, whereby excellent battery characteristic will be obtainable.

In particular, if the peak P2 is further detected in the result of analysis of the positive electrode 21 by ²⁵Mg-NMR, the charge-discharge reaction based on deposition/dissolution of magnesium will proceed in a sufficiently stable manner for the reasons above, whereby a higher effect will be obtainable.

If the peak intensity ratio is 0.05 or larger, the relationship between the intensity I1 and the intensity I2 will be well balanced. Since a high battery capacity will stably be obtainable, a higher effect will therefore be obtainable.

Next, a modified example of the secondary battery will be described. Note a series of modified examples described below may be appropriately combined.

The trimagnesium disulfide-containing compound, being a reversible discharge product, has been designed to be formed when the secondary battery is allowed to discharge, and to disappear when the secondary battery is charged.

The trimagnesium disulfide-containing compound may, however, remain without disappearing when the secondary battery is charged, so that a part of, or the entire the trimagnesium disulfide-containing compound may remain. In this case, the amount of the trimagnesium disulfide-containing compound may increase, as a result of repetitive charge-discharge of the secondary battery. Also in this case, the same effect is obtainable, making use of the property of the trimagnesium disulfide-containing compound.

The trimagnesium disulfide-containing compound, being a discharge product, has been designed to be formed making use of the discharge reaction of the secondary battery. This trimagnesium disulfide-containing compound is, however, not necessarily the discharge product, since it is formed by any of known synthesis methods.

In this case, the sulfur-containing material in the undischarged state may contain the trimagnesium disulfide-containing compound. The trimagnesium disulfide-containing compound contains trimagnesium disulfide, as described previously. Also in this case, the same effect is obtainable, making use of the property of the trimagnesium disulfide-containing compound.

FIGS. 2 and 3 have illustrated the cases with use of the electrolytic solution which is a liquid electrolyte. It is, however, acceptable to use an electrolyte layer formed of a gel-like electrolyte, in place of the electrolytic solution, although not specifically illustrated herein.

In the battery element 20 with use of the electrolyte layer, the positive electrode 21 and the negative electrode 22 are opposed and rolled, while placing the separator 23 and the electrolyte layer in between. The electrolyte layer is interposed between the positive electrode 21 and the separator 23, and is interposed between the negative electrode 22 and the separator 23.

More specifically, the electrolyte layer contains any one kind of, or two or more kinds of polymer compounds, together with the electrolytic solution, and the electrolytic solution is retained by the polymer compound. This is because the electrolytic solution can be prevented from leaking. The structure of the electrolytic solution is as described previously.

Specific examples of the polymer compound include polyacrylonitrile, polyvinylidene fluoride, vinylidene fluoride-hexafluoropropylene copolymer, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, polyacrylic acid, polymethacrylic acid, styrene-butadiene rubber, nitrile-butadiene rubber, polystyrene, and polycarbonate. Among them, polyacrylonitrile, polyvinylidene fluoride, polyhexafluoropropylene, and polyethylene oxide are preferred. This is because the electrochemical stability of the polymer compound is improved.

In a case of forming the electrolyte layer, a precursor solution that contains the electrolytic solution, the polymer compound, and the solvent is prepared, and then the precursor solution is coated on one face, or on both faces of each of the positive electrode 21 and the negative electrode 22.

Also in such case of using the electrolyte layer, magnesium can migrate between the positive electrode 21 and the negative electrode 22 through the electrolyte layer, making it possible to obtain similar effects. In particular in this case, liquid leakage of the electrolytic solution is prevented as described previously, making it possible to obtain enhanced effects.

The application (application example) of the secondary battery is not particularly limited. The secondary battery used as a power supply may be used as a main power supply or an auxiliary power supply, in applications such as electronic devices and electric vehicles. The main power supply is a power supply that is preferentially used regardless of the presence or absence of other power supplies. The auxiliary power supply may be a power supply used in place of the main power supply, or may be a power supply switched from the main power supply.

Specific examples of applications of the secondary battery are as described below: electronic devices such as video camera, digital still camera, mobile phone, laptop computer, stereophone, portable radio, and personal digital assistant; backup power supply, and memory device such as memory card; power tools such as power drill and power saw; battery pack mounted on electronic device or the like; medical electronics such as pacemaker and hearing aids; electric vehicle such as electric car (including hybrid car); and electric power storage system for storing electric power for emergencies or the like, such as home or industrial battery system. In these applications, only one secondary battery may be used, or two or more secondary batteries may be used.

The battery pack may use single battery or assembled battery. The electric vehicle is a vehicle that travels with use of the secondary battery as a driving power supply, and may also be a hybrid car that additionally has a drive source other than the secondary battery. With the home electric power storage system, home electric appliances and the like are operable with use of electric power accumulated in the secondary battery as an electric power storage source.

### Examples

Examples of the present technology will be described according to an embodiment.

Examples 1 and 2, and Comparative Examples 1 to 3 As described below, a secondary battery having a test electrode 51 described later was manufactured, the physical properties of the test electrode 51 were then evaluated, and the battery characteristics of the secondary battery were evaluated.

### Manufacture of Secondary Battery

The test secondary battery was manufactured, in order to conveniently evaluate each of the physical properties and the battery characteristics. FIG. 6 illustrates a cross-sectional structure of the test secondary battery. The test secondary battery is a coin-type magnesium-sulfur secondary battery.

The paragraphs below will first describe the structure of the test secondary battery, and will then describe the procedures for manufacturing the test secondary battery.

### Structure of Test Secondary Battery

The test secondary battery has, as illustrated in FIG. 6, a test electrode 51, a counter electrode 52, a separator 53, an exterior cup 54, an exterior can 55, a gasket 56, and an electrolytic solution (not illustrated).

The test electrode 51 is accommodated in a bowl-like exterior cup 54, and the counter electrode 52 is accommodated in a bowl-like exterior can 55. The test electrode 51 and the counter electrode 52 are stacked while placing the separator 53 in between, and the electrolytic solution is impregnated individually into the test electrode 51, the counter electrode 52, and the separator 53. The exterior cup 54 is accommodated in the exterior can 55, and the exterior cup 54 and the exterior can 55 are caulked with the gasket 56 interposed in between. In this way, the test electrode 51, the counter electrode 52, and the separator 53 are enclosed inside the exterior cup 54 and the exterior can 55.

### Procedures for Manufacturing Test Secondary Battery

The procedures for manufacturing the test secondary battery are as described below.

### Manufacture of Test Electrode

First, 10 parts by mass of a positive electrode active material (elemental sulfur (S, purity=99% or above) as the sulfur-containing material, from Sigma-Aldrich), 30 parts by mass of a positive electrode binder (polytetrafluoroethylene, from AGC Inc.), and 60 parts by mass of a positive electrode conductive agent (Ketjen black ECP600JD, from Lion Corporation) were mixed, to obtain a positive electrode mixture.

Next, the positive electrode mixture was molded into a layer with use of a molding machine, to form a positive electrode active material layer. The areal density of the sulfur-containing material in this case was adjusted to 3.0 mg/cm².

Next, the positive electrode active material layer was punched into a disk shape (diameter=15 mm), to obtain a disk-shaped positive electrode active material layer.

Lastly, the positive electrode active material layer was stacked on one face of the positive electrode current collector (nickel foil), and the positive electrode active material layer was press-bonded to the positive electrode current collector with use of a molding machine. The test electrode 51 was thus manufactured.

For comparison, a test electrode 51 was prepared by the same procedures, except that the areal density of the sulfur-containing material was changed to 0.6 mg/cm².

### Preparation of Counter Electrode

A disk-shaped magnesium plate was prepared as the counter electrode 52 (elemental magnesium (Mg) as the magnesium-containing material). In this case, a magnesium plate (thickness=0.2 mm, diameter=16 mm, purity=99.9%) from Rikazai Co., Ltd. was used.

### Preparation of Electrolytic Solution

Inside a glove box (argon gas atmosphere, dew point=−90° C. to −80° C.), a solvent (dialkylsulfone or ether compound as the non-aqueous solvent) was kept stirred with use of a stirrer, and an electrolyte salt (magnesium salt) was placed in the solvent. The ratio (molar ratio) of mixing of the solvent and the electrolyte salt in this case was adjusted to solvent: electrolyte salt=80:10.

Dialkylsulfone used herein was ethyl-n-propylsulfone (EnPS) of dehydration grade for battery, from Tomiyama Pure Chemical Industries, Ltd. The ether compound used herein was dimethoxyethane (DME). The magnesium salts used herein were anhydrous magnesium chloride (MgCl₂) from Sigma-Aldrich, and magnesium bis(trifluoromethanesulfonyl)imide (Mg(TFSI)₂) from Tomiyama Pure Chemical Industries, Ltd.

The electrolytic solution was thus prepared. Composition of the electrolytic solution is as listed in Table 1.

In a case where ethyl-n-propylsulfone was used as the solvent, and magnesium chloride was used as the electrolyte salt, the content of the electrolyte salt in the electrolytic solution was adjusted to 1 mol/l (=1 mol/dm³) with respect to the solvent.

In a case where dimethoxyethane was used as the solvent, and a mixture of magnesium chloride and magnesium bis(trifluoromethanesulfonyl)imide was used as the electrolyte salt, the content of the electrolyte salt (magnesium chloride) in the electrolytic solution was adjusted to 2 mol/l (=2 mol/dm³) with respect to the solvent, and the content of the electrolyte salt (magnesium bis(trifluoromethanesulfonyl)imide) in the electrolytic solution was 1 mol/l (=1 mol/dm³) with respect to the solvent.

For comparison, an electrolytic solution was prepared by the same procedures, except that a cyclic carbonate (propylene carbonate (PC)) was used as the nonaqueous solvent, in place of dialkylsulfone. In this case, the electrolyte salt was not fully dissolved, thus making the content of the electrolyte salt in the electrolytic solution less than 1 mol/l (=1 mol/dm³) with respect to the solvent.

For comparison, an electrolytic solution was prepared by the same procedures, except that water (H₂O) as the aqueous solvent was used, in place of the nonaqueous solvent. Also in this case, the electrolyte salt was not fully dissolved, thus making the content of the electrolyte salt in the electrolytic solution less than 1 mol/l (=1 mol/dm³) with respect to the solvent.

### Assembly of Test Secondary Battery

First, a spacer (stainless steel plate, thickness=0.5 μm) was spot-welded to an inner bottom face of the exterior cup 54. The position of welding of a spacer to the exterior cup 54 in this case was adjusted so that the spacer will be interposed between the exterior cup 54 and the test electrode 51 which will be accommodated in the exterior cup 54 in the subsequent step. Note FIG. 6 does not illustrate the spacer.

Next, the test electrode 51 was accommodated in the exterior cup 54, and the counter electrode 52 was accommodated in the exterior can 55. Next, the test electrode 51 accommodated in the exterior cup 54 and the counter electrode 52 accommodated in the exterior can 55 were stacked, while placing in between the separator 53 (glass filter GC50 from Advantech Co., Ltd.) impregnated with the electrolytic solution. In this case, the test electrode 51 was disposed so as to oppose the positive electrode active material layer formed on one face of the positive electrode current collector, to the counter electrode 52, while placing the separator 53 in between. Lastly, the exterior cup 54 and the exterior can 55 were caulked while placing the gasket 56 in between, with the test electrode 51 and the counter electrode 52 stacked while placing the separator 53 in between. In this way, the test electrode 51 and the counter electrode 52 were enclosed inside the exterior cup 54 and the exterior can 55, whereby the test secondary battery was completed.

### Evaluation of Physical Properties

Physical properties of the test electrode 51 were evaluated, to obtain results summarized in Table 1.

When evaluating the physical properties of the test electrode 51, first, the test secondary battery was allowed to discharge at a current of 0.2 mA until the battery voltage reached 0.4 V. Next, the test secondary battery was disassembled, and the test electrode 51 was taken out. Next, the test electrode 51 was analyzed by ²⁵Mg-NMR, to obtain a result of analysis (result of ²⁵Mg-NMR analysis) of the test electrode 51. In this case, the positive electrode active material layer that contains the sulfur-containing material was analyzed.

Lastly, whether each of the peaks P1 and P2 was detected or not was examined with reference to the result of ²⁵Mg-NMR analysis, and the peak intensity ratio was estimated. Details regarding the analysis procedures, calculation procedures and the like are as described previously.

### Evaluation of Battery Characteristics

Capacity characteristic was evaluated as one physical property, to obtain results summarized in Table 1.

When evaluating the capacity characteristic, the test secondary battery was subjected to two cycles of charge-discharge in an ambient temperature environment (temperature=25° C.), in order to electrochemically stabilize the state of the test secondary battery. Thereafter, the test secondary battery was subjected to charge-discharge in the same environment, to measure the battery capacity (mAh) which is an index for evaluating the capacity characteristic.

The discharge was conducted by constant current discharge at a current of 0.2 mA until the battery voltage reached down to 0.4 V, meanwhile the charge was conducted by constant-current charge at a current of 0.2 mA until the battery voltage reached 2.4 V.

TABLE 1

| | | | Negative | | | | | | |
|---|---|---|---|---|---|---|---|---|---|
| | Positive electrode | | electrode | | | Result of 25 Mg-NMR analysis | | | |
| | Sulfur- | Areal | Magnesium- | Electrolytic solution | | | | Peak | Battery |
| | containing | density | containing | | Electrolyte | Peak | Peak | intensity | capacity |
| | material | (mg/cm²) | material | Solvent | salt | P1 | P2 | ratio | (mAh) |
| Example 1 | S | 3.0 | Mg | EnPS | MgCl₂ | Detected | Detected | 0.5 | 6.2 |
| Example 2 | S | 3.0 | Mg | DME | MgCl₂ + | Detected | Detected | 2 | 6.2 |
| | | | | | Mg | | | | |
| | | | | | (TFSI)₂ | | | | |
| Comparative | S | 0.6 | Mg | EnPS | MgCl₂ | Not | Detected | — | 1.8 |
| Example 1 | | | | | | detected | | | |
| Comparative | S | 3.0 | Mg | PC | MgCl₂ | Not | Detected | — | Charge/ |
| Example 2 | | | | | | detected | | | discharge |
| | | | | | | | | | impossible |
| Comparative | S | 3.0 | Mg | H₂O | MgCl₂ | Not | Detected | — | Charge/ |
| Example 3 | | | | | | detected | | | discharge |
| | | | | | | | | | impossible |

As summarized in Table 1, the battery capacity was found to largely vary, depending on the structure of the test secondary battery.

More specifically, high battery capacity was not obtainable, for the cases where the peak P1 was not detected in the result of ²⁵Mg-NMR analysis, that is, for the cases where the sulfur-containing material did not contain the trimagnesium disulfide-containing compound as the discharge product, in the discharged state (Comparative Examples 1 to 3).

In particular, the cases where the solvent contained neither dialkylsulfone nor ether compound (Comparative Examples 2 and 3) were not found to cause the charge-discharge reaction at all.

In contrast, high battery capacity was obtained, for the cases where the peak P1 was detected in the result of ²⁵Mg-NMR analysis, that is, for the cases where the sulfur-containing material contained the trimagnesium disulfide-containing compound as the discharge product, in the discharged state (Examples 1 and 2).

In particular, in a case where the peak P1 was detected in the result of ²⁵Mg-NMR analysis, a series of tendencies described below was obtained.

First, in a case where the peak P2 was further detected in the result of ²⁵Mg-NMR analysis, a high battery capacity was obtained since the sulfur-containing material contained magnesium sulfide together with trimagnesium disulfide, in the discharged state. Magnesium sulfide in this case was found to have a zinc blende-type crystal structure, as a result of analysis of the test electrode 51 by solid-state ²⁵Mg-NMR.

Second, with the sulfur-containing material having elemental sulfur contained therein, high battery capacity was obtained due to formation of trimagnesium disulfide.

Third, with the areal density of the sulfur-containing material adjusted to 1 mg/cm² to 10 mg/cm² in the test electrode 51, high battery capacity was obtained due to formation of trimagnesium disulfide.

In contrast, with an areal density of the sulfur-containing material of smaller than 1 mg/cm² in the test electrode 51, high battery capacity was not obtained since trimagnesium disulfide was not formed.

Fourth, in a case where the solvent contained dialkylsulfone or ether compound, and the electrolyte salt contained the magnesium salt, high battery capacity was obtained due to formation of trimagnesium disulfide.

In contrast, even if the electrolyte salt contained the magnesium salt, the charge-discharge reaction did not proceed at all as described previously, unless the solvent contained dialkylsulfone or ether compound.

Fifth, with the magnesium-containing material having elemental magnesium contained in the counter electrode 52, high battery capacity was obtained due to formation of trimagnesium disulfide.

Sixth, with the peak intensity ratio adjusted to 0.05 or larger, high battery capacity was obtained.

Judging from the results summarized in Table 1, the charge-discharge reaction based on deposition/dissolution of magnesium was allowed to proceed stably and high battery capacity was obtained, if the positive electrode 21 contained the sulfur-containing material, the negative electrode 22 contained the magnesium-containing material, and the sulfur-containing material contained trimagnesium disulfide in the discharged state. This improved the capacity characteristic, whereby excellent battery characteristics were obtained.

Again judging from the results summarized in Table 1, the charge-discharge reaction based on deposition/dissolution of magnesium was allowed to proceed stably and high battery capacity was obtained, if the positive electrode 21 contained the sulfur-containing material, the negative electrode 22 contained the magnesium-containing material, and the peak P1 was detected in the result of analysis by ²⁵Mg-NMR of the test electrode 51 in the discharged state. This improved the capacity characteristic, whereby excellent battery characteristics were obtained.

It was also found that the secondary battery, to which trimagnesium disulfide as the trimagnesium disulfide-containing compound was applied, was found to have high battery capacity. Therefore, an electrochemical device having excellent electrochemical characteristics was obtained with use of the trimagnesium disulfide-containing compound.

The present technology has been described with reference to an embodiment including Examples. The present technology is, however, not limited thereto, and thus may be variously modified.

For example, the description has been made on the secondary batteries having battery structures of laminate film type and coin type. The battery structure of the secondary battery is, however, not particularly limited, and may be of cylindrical type, prismatic type, button type, or the like.

The description has been made on the battery element having an element structure of rolled type. The element structure of the battery element is, however, not particularly limited, and may be of layered type or zigzag-folding type, or the like. The layered type has the positive electrode and the negative electrode layered therein, meanwhile the zigzag-folding type has the positive electrode and the negative electrode folded in a zigzag manner.

The effects described in the present specification are merely exemplary, to which the effects of the present technology are not limited. Any other effects may therefore be obtainable regarding the present technology.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode that includes a sulfur-containing material;
a negative electrode that includes a magnesium-containing material; and
an electrolytic solution, wherein
the sulfur-containing material includes trimagnesium disulfide (Mg₃S₂) in a discharged state.

2. The secondary battery according to claim 1, wherein
the sulfur-containing material further includes magnesium sulfide (MgS) in the discharged state.

3. The secondary battery according to claim 2, wherein
the magnesium sulfide has a zinc blende-type crystal structure.

4. The secondary battery according to claim 1, wherein
the sulfur-containing material includes elemental sulfur(S).

5. The secondary battery according to claim 1, wherein
the positive electrode includes a positive electrode active material layer,
the positive electrode active material layer includes the sulfur-containing material, and
the sulfur-containing material in the positive electrode active material layer has an areal density of 1 mg/cm² or larger and 10 mg/cm² or smaller.

6. The secondary battery according to claim 1, wherein
the electrolytic solution includes a solvent and an electrolyte salt,
the solvent includes at least either dialkylsulfone or an ether compound, and
the electrolyte salt includes a magnesium salt.

7. The secondary battery according to claim 1, wherein
the magnesium-containing material includes elemental magnesium (Mg).

8. The secondary battery according to claim 1, given as a magnesium-sulfur secondary battery.

9. A secondary battery comprising:
a positive electrode that includes a sulfur-containing material;
a negative electrode that includes a magnesium-containing material; and
an electrolytic solution, wherein
the sulfur-containing material includes sulfur and magnesium as constituent elements in a discharged state, and
the positive electrode in a discharged state demonstrates, in a result of analysis by magnesium-25 nuclear magnetic resonance spectroscopy, a first peak in a range of chemical shift from −70 ppm or larger to 0 ppm or smaller.

10. The secondary battery according to claim 9, wherein
the positive electrode in the discharged state further demonstrates, in the result of analysis by magnesium-25 nuclear magnetic resonance spectroscopy, a second peak in a range of chemical shift from 60 ppm or larger to 80 ppm or smaller.

11. The secondary battery according to claim 10, wherein
a ratio of peak intensity of the first peak to peak intensity of the second peak is 0.05 or larger.

12. A trimagnesium disulfide-containing compound comprising
trimagnesium disulfide (Mg₃S₂).
